(19) United States
(12) Patent Application Publication
(10) Pub. No.: US 2023/0114760 A1
(43) Pub. Date: Apr. 13, 2023

(54) NETWORK-ON-CHIP (NoC) USING DEADLINE BASED ARBITRATION

(71) Applicant: ARTERIS, INC., Campbell, CA (US)

(72) Inventors: Michael FRANK, Sunnyvale, CA (US); Benoit de LESCURE, Campbell, CA (US)

(73) Assignee: ARTERIS, INC., Campbell, CA (US)

(21) Appl. No.: 17/955,476

(22) Filed: Sep. 28, 2022

Related U.S. Application Data
(60) Provisional application No. 63/249,033, filed on Sep. 28, 2021.

(51) Int. Cl. H04L 45/02; H04L 12/43; H04L 45/00

(52) U.S. Cl. CPC H04L 45/02; H04L 12/43; H04L 45/22

(57) ABSTRACT

A system and method to arbitrate based on a deadline in a network-on-chip (NoC) is disclosed. When a packet is created, a deadline is determined based on desired routing and the deadline is included in the packet. As the packet is routed through the NoC, the deadline is adjusted when a packet is not selected by an arbiter to progress. At an arbiter, when multiple packets are contending for an output port, the deadline is used to determine the packet to progress.

### CROSS REFERENCE TO RELATED APPLICATION

This application claims priority under 35 USC 119 to U.S. Provisional App. Serial No. 63/249,033 filed on Sep. 28, 2021 and titled DEADLINE BASED ARBITRATION IN A NETWORK-ON-CHIP by Benoit DE LESCURE et al., the entire disclosure of which is incorporated herein by reference.

### TECHNICAL FIELD

The present technology is in the field of computer system design and, more specifically, related to a network packet routing scheme for a network-on-chip (NoC).

### BACKGROUND

Within a network-on-chip (NoC), packets may be transported from an initiator to a target. Networks-on-chip (NoCs) are built by assembling various components such as switches, buffers, network interfaces, adapters, etc.

In general, within a switch, each output port of the switch has an arbiter that determines which packet to output on a given output port. For example, the arbiter can have two packets contenting to be output and the arbiter will decide which packet to output. Various approaches resolve this contention in an arbiter. For example, with round robin (RR), each contending packet is assigned a position in a wait list and contending packets are granted access to the output port in that order; the start of the list being always set after the last port that was served. Other examples include, first in first out (FIFO), priority based, weighted round robin (WRR), etc.

NoC designers need the arbiters to resolve contention fairly. In general, arbiters resolve contentions in a fair manner, which means every packet has approximately the same chance to win arbitration, and no packet is ever blocked for an infinite period of time. Even though each arbiter chooses in a fair manner, paths within the NoC that contain many switches and other packet routing components can produce an unfair route. For example, when a path has many switches, the probability of a given path going through is lowered especially on networks with a large amount of data. To help make arbitration less sensitive to the depth of the switch cascade packets go through, solutions can include regulation at the initiator, dynamic priority of packets based on obtained bandwidth versus a set goal, and other mechanisms such as pressure through the cascade. However, these mechanisms typically do not work well in situations where cascades are very deep such as in mesh-type topologies where packets need to go through many nodes (e.g., switches with arbiters) between an initiator and a target. Furthermore, these mechanisms typically focus on request arbitration and do not address the situation of corresponding response packet arbitration.

For the NoC to run efficiently, the time a packet takes to be routed through the network needs to be managed within an acceptable standard. For example, an acceptable standard could be a certain level of quality of service for the packet sender. Therefore, what is needed is an arbitration scheme that allows packets to be delivered to a target within a certain time interval.

### SUMMARY

In accordance with various embodiments and aspects of the invention, an arbitration scheme is disclosed that allows packets to be delivered to a target within a certain time interval or a deadline. The disclosed systems and methods allow packets to be routed or delivered to a target within a certain time interval or by a certain deadline. According to one or more aspects and embodiments of the invention, a deadline is created for a packet to be delivered; the packet is created that includes the deadline. The deadline may be part of the packet header. The packet is routed within a network-on-chip (NoC) using the deadline. For example, when two packets are contending for an output port, the deadline may be used to arbitrate which packet is to progress. For another example, when two packets are contending for an output port, the packet with the smallest deadline is the packet that will progress. The deadline may be adjusted at each component the packet passes through. For example, the deadline may be given a fixed value at the beginning and the deadline decremented at each component the packet passes through.

According to one or more aspects and embodiments of the invention, when a packet is created, a deadline is calculated based on desired routing and the deadline is set as a field in the header. As the packet is routed through the NoC, the deadline is decremented when a packet is not selected by an arbiter to progress. At an arbiter, the packet with the smallest deadline is chosen to progress.

According to one or more aspects and embodiments of the invention, a packet can have a deadline and a priority. A combination of deadline and/or priority may be used to determine a packet to progress when multiple packets are contending for an output port. According to one or more aspects and embodiments of the invention, when two packets are contending for an output port and both packets have the same priority, the packet with the smallest deadline is the packet that will progress. According to one or more aspects and embodiments of the invention, when two packets are contending for an output port and both packets have the same deadline, the packet with the highest priority is the packet that will progress.

According to one or more aspects and embodiments of the invention, when two or more packets have the same deadline and are contending for an output port, an arbitration scheme is used to determine the packet to progress. According to one or more aspects and embodiments of the invention, a deadline may be set to a reserved value and arbitration may depend on the reserved value. For example, a packet with a deadline that is a reserved value may lose arbitration to another packet whose deadline is not a reserved value. According to one or more aspects and embodiments of the invention, packets make include packets that have a deadline and packets that do not have a deadline. Routing may be based on if a packet has a deadline. For example, packets with a deadline may win arbitration over a packet without a deadline.

According to one or more aspects and embodiments of the invention, one or more request packets correspond to one or more response packets. For example, an initiator sends a request to a target and the target returns a response. A deadline is calculated in such a way as to set a time that a response will be received. When the request is created, the deadline is included. As the request is routed to the destination using the deadline, the deadline may be adjusted by the components the packet passes through. While at the destination, the deadline is adjusted to account for the time to create a response. When the response is created, the deadline is included in the response. As the response is routed to the initiator using the deadline, the deadline is adjusted. According to one or more aspects and embodiments of the invention, the target stores the deadline in a context table and adjusts the deadline in the context table while waiting on a response.

According to one or more aspects and embodiments of the invention, a deadline may be adjusted by a variable amount. For example, the packet with a smaller deadline (e.g., older packet) may have the deadline decremented by a larger value. For another example, packets with a higher priority have the deadline decremented with a larger value compared to packets with a lower priority.

According to one or more aspects and embodiments of the invention, the value of the deadline can be used to monitor network performance. According to one or more aspects and embodiments of the invention, the remaining deadline of packets may be adjusted to achieve a desired network performance.

### BRIEF DESCRIPTION OF THE DRAWINGS

In order to understand the invention more fully, reference is made to the accompanying drawings. The invention is described in accordance with the aspects and embodiments in the following description with reference to the drawings or figures (FIG.), in which like numbers represent the same or similar elements. Understanding that these drawings are not to be considered limitations in the scope of the invention, the presently described aspects and embodiments and the presently understood best mode of the invention are described with additional detail through use of the accompanying drawings.

FIG. 1A shows a switch in accordance with the various aspects and embodiments of the invention.

FIG. 1B shows a switch in accordance with the various aspects and embodiments of the invention.

FIG. 2 shows a network-on-chip (NoC) in accordance with the various aspects and embodiments of the invention.

FIG. 3 shows a mesh topology NoC in accordance with the various aspects and embodiments of the invention.

FIG. 4 shows a process of using deadline based arbitration in accordance with the various aspects and embodiments of the invention.

FIG. 5 shows a process of using deadline based arbitration in accordance with the various aspects and embodiments of the invention.

FIG. 6 shows modules for using deadline based arbitration within a NoC in accordance with the various aspects and embodiments of the invention.

FIG. 7 shows a process of using deadline based arbitration in a request and response cycle in accordance with the various aspects and embodiments of the invention.

FIG. 8 shows an initiator communicating with a target through a NoC using deadline based arbitration in a request and response cycle in accordance with the various aspects and embodiments of the invention.

FIG. 9A illustrates a rotating disk non-transitory computer readable medium, according to an embodiment of the invention.

FIG. 9B illustrates a flash random access memory non-transitory computer readable media, according to an embodiment of the invention.

FIG. 10A illustrates the bottom side of a computer processor based system-on-chip, according to an embodiment of the invention.

FIG. 10B illustrates the top side of a computer processor based system-on-chip, according to an embodiment of the invention.

FIG. 11 shows a block diagram of a system-on-chip for devices, according to an embodiment of the invention.

### DETAILED DESCRIPTION

The following describes various examples of the present technology that illustrate various aspects and embodiments of the invention. Generally, examples can use the described aspects in any combination. All statements herein reciting principles, aspects, and embodiments as well as specific examples thereof, are intended to encompass both structural and functional equivalents thereof. The examples provided are intended as non-limiting examples. Additionally, it is intended that such equivalents include both currently known equivalents and equivalents developed in the future, i.e., any elements developed that perform the same function, regardless of structure.

It is noted that, as used herein, the singular forms “a,” “an” and “the” include plural referents unless the context clearly dictates otherwise. Reference throughout this specification to “one embodiment,” “an embodiment,” “certain embodiment,” “various embodiments,” or similar language means that a particular aspect, feature, structure, or characteristic described in connection with the embodiment is included in at least one embodiment of the invention.

Thus, appearances of the phrases “in one embodiment,” “in at least one embodiment,” “in an embodiment,” “in certain embodiments,” and similar language throughout this specification may, but do not necessarily, all refer to the same embodiment or similar embodiments. Furthermore, aspects and embodiments of the invention described herein are merely exemplary, and should not be construed as limiting of the scope or spirit of the invention as appreciated by those of ordinary skill in the art. The disclosed invention is effectively made or used in any embodiment that includes any novel aspect described herein. All statements herein reciting principles, aspects, and embodiments of the invention are intended to encompass both structural and functional equivalents thereof. It is intended that such equivalents include both currently known equivalents and equivalents developed in the future.

The terms “source,” “master,” and “initiator” refer to similar intellectual property (IP) modules/blocks or units; these terms are used interchangeably within the scope and embodiments of the invention. As used herein, the terms “sink,” “slave,” and “target” refer to similar IP modules or units and the terms are used interchangeably within the scope and embodiments of the invention. As used herein, a transaction may be a request transaction or a response transaction. Examples of request transactions include write request and read request.

Various references are made herein to integrated circuits (ICs) and the designs of ICs. One example of an IC is a multiprocessor system that is implemented in systems-on-chip (SoCs) that communicates through networks-on-chip (NoCs). The SoCs include instances of initiator intellectual properties (IPs) and target IPs. Transactions are sent from an initiator to one or more targets using industry-standard protocols. The initiator, connected to the NoC, sends a request transaction to a target or targets, using an address to select the target or targets. The NoC decodes the address and transports the request from the initiator to the target. The target handles the transaction and sends a response transaction, which is transported back by the NoC to the initiator. As such, the SoC and NoC include complexity and configurability, especially in situation when the NoC is configurable.

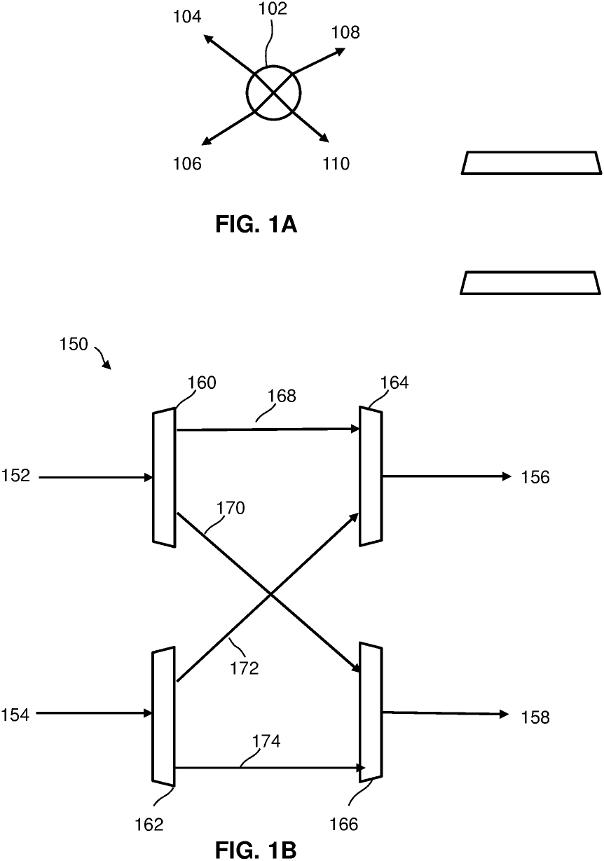

Referring now to FIG. 1A, shown is a switch 102 in accordance with the various aspects and embodiments of the invention. According to one or more aspects and embodiments of the invention, switch 102 can select input ports 104 and 106 to connect with or output onto output ports 108 and 110. For example, switch 102 may output a packet from input port 104 or 106 to output port 108. For another example, switch 102 may output a packet from input port 104 pr 106 to output port 110.

Referring now to FIG. 1B, shown is a switch 150 in accordance with the various aspects and embodiments of the invention. According to one or more aspects and embodiments of the invention, switch 150 has input ports 152 and 154, and output ports 156 and 158. Multiplexer 160 switches input port 152 between signal paths 168 and 170. Multiplexer 162 switches input port 154 between signal paths 172 and 174. As used herein, multiplexer may be referred to as a switch or a selector. Arbiter 164 selects between signal path 168 and 172 to determine which signal to output on output port 156. Arbiter 166 selects between signal path 170 and 174 to determine which signal to output on output port 158. In accordance with various aspect and embodiments of the invention, arbiters 164 and/or 166 may use any arbitration scheme (e.g., round robin, first in first out (FIFO), priority based, weighted round robin, etc.). In accordance with various aspect and embodiments of the invention, arbiters 164 and 166 may implement different arbitration schemes.

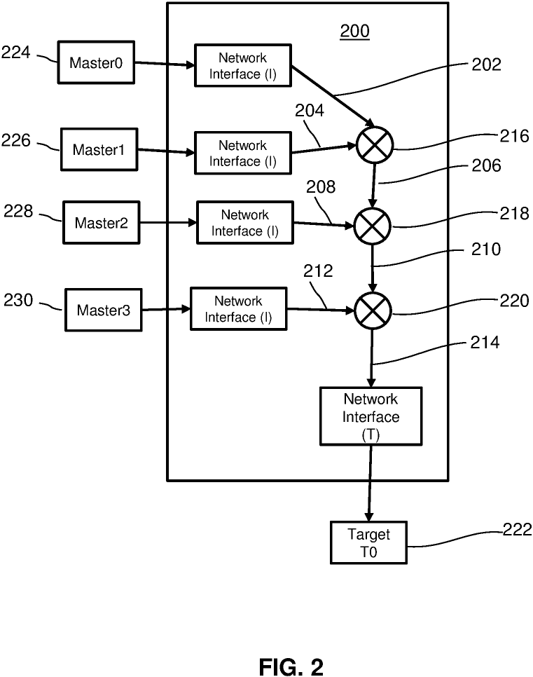

Referring now to FIG. 2, shown is a network-on-chip (NoC) 200 with masters 224, 226, 228, and 230 connected thereto in accordance with the various aspects and embodiments of the invention. In accordance with various aspect and embodiments of the invention, NoC 200 may have a large number of switches and other routing components which can create a long path for a packet to travel. For example, a multicomponent path between components, such as initiator or master 224 and target 222, may be arbitrated against multiple packets at multiple switches between master 224 and target 222.

Even though each arbiter in the path between master 224 and target 222 may be fair, the cascaded combination of switches may not be fair. For example, FIG. 2 shows cascaded switches 216, 218, and 220 that route packets, initiators (masters 224, 226, 228, and 230), and target 222. When each switch has a fair arbitration scheme, at switch 220 signal path 210 and 212 would both have a 50% chance of winning arbitration. In other words, if a packet arrived at switch 220 on signal path 212 at the same time another packet arrived on signal path 210, each packet would have a 50% (100% divided by number of input ports) chance of being sent to target 222 via signal path 214. As a packet on signal path 210 has a 50% chance of being sent to target 222, the signal path 206 and 208 each have a 25% (50%/2) chance of being sent to target 222. As a packet on signal path 206 has a 25% chance of being sent to target 222, the signal path 202 and 204 each have a 12.5% (25%/2) chance of being sent to target 222. The preceding example illustrates that a purely local arbitration scheme that ignores the past life or path of a packet can create an overall unfair arbitration at a NoC level even though the arbitration scheme is fair at each individual arbiter.

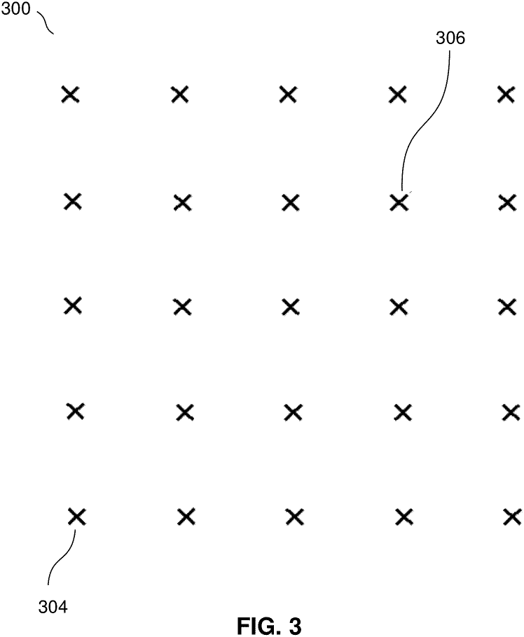

Referring now to FIG. 3, shown is a mesh topology network-on-chip (NoC) 300 in accordance with the various aspects and embodiments of the invention. In mesh topology NoC 300, an “X” represents a switch or node that is connected to various IP blocks, such as initiator 304 and target 306. Each switch is connected to a nearby switch using an edge or link (not shown). On average a packet goes through ~N switches if the size of the mesh is NxN, with the worst case path length equal to 2*N - 1 switches.

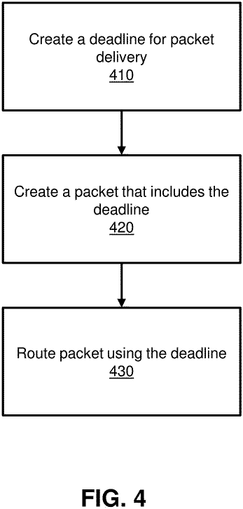

Referring now to FIG. 4, shown is a process of using deadline based arbitration within a NoC in accordance with the various aspects and embodiments of the invention. At step 410, a deadline is created for packet delivery. The deadline may represent the maximum amount of time given to a transaction to complete or reach a destination. The deadline may ensure a performance level is met for an initiator attached to the NoC. In accordance with various aspects and embodiments of the invention, the deadline may represent the encoded value of a time, in some unit of time that is the same for all packet senders. In accordance with various aspects and embodiments of the invention, the deadline may represent the encoded value of a time, in some unit of time that is the same for some packet senders and different for others, depending on the arbitration scheme implemented. The deadline may be independent of the sender’s own clock speed or clock domain. The encoded time value in the deadline may be the expected maximum time the packet is allowed (total duration) to reach a target. The encoded time value in the deadline may be the expected maximum time the packet is allowed to reach a target and a response returned. The deadline may be expressed in a chosen time unit.

Network Interface Units (NIUs) may build and send packets in a NoC. An NIU may compute a deadline for a packet. The computation of the deadline may depend on where the NIU is located. The computation of the deadline may be dependent on the goals in terms of quality of service.

At step 420, a packet is created that includes the deadline. According to one or more aspects and embodiments of the invention, the deadline is added to the packet header. According to one or more aspects and embodiments of the invention, at request packet creation, a deadline is computed and added to the header of the packet. According to one or more aspects and embodiments of the invention, at request packet creation, a deadline is computed and added to the address or part of the payload of the packet.

At step 430, the packet is routed within the NoC using or based on the deadline. According to one or more aspects and embodiments of the invention, when a packet is not chosen to be outputted from a switch, the deadline may be decremented by a value. In other words, when a packet loses arbitration (with respect to another packet), the deadline may be decremented by a value. According to one or more aspects and embodiments of the invention, for the deadline to be decremented, a packet must have not been chosen for a fixed number of clock cycles. According to one or more aspects and embodiments of the invention, the decremented value may be a fixed value. The decremented value may be s(SWx). The value of ε(SWx) may be unique for each component (e.g., switch) in the NoC. The value of ε(SWx) may represent the time the packet has waited at the arbiter. The value of ε(SWx) may be changed over time. The value of ε(SWx) may depend on the operating frequency (clock domain) of the switch. The value of ε(SWx) may depend on how many clock cycles the switch requires to make an arbitration decision.

According to one or more aspects and embodiments of the invention, an arbiter inside a switch makes an arbitration decision based on the deadline of each contenting packet. The arbiter may select the packets with the smallest deadlines with the highest priority. The arbiter may select the packet that has been in the NoC the longest. When multiple packets have the same deadline, a secondary arbitration mechanism (e.g., round robin, or other arbitration scheme) may be used to resolve the tie.

According to one or more aspects and embodiments of the invention, the sorting function that the arbiter uses to find the smallest deadline value can be precise or imprecise. Imprecise comparisons may be simpler and faster in hardware implementation. Imprecise comparisons might consider equal all the values inside an interval. According to one or more aspects and embodiments of the invention, any sorting function may be used.

According to one or more aspects and embodiments of the invention, in addition to arbiters, each NoC component (e.g., buffers and adapters), which can store a packet for more than one clock cycle, may modify the deadline. For example, for a packet waiting inside the component Ux for a given number of clock cycles (e.g., one or more clock cycles), the value of the deadline for that packet, which may be the header, can be decremented by a fixed number ε(Ux) representing the time the packet has waited inside this component Ux.

According to one or more aspects and embodiments of the invention, at request packet creation, a deadline is computed and added to the header of the packet. As the packet flows through the NoC, at each stop for arbitration, the deadline is decremented for a value depending on the time the packet is waiting. In an arbiter within the NoC, a packet with the smallest deadline (of all the packets waiting for selection) is chosen and the chosen packet is transmitted. When multiple packets have the smallest deadline, an arbitration scheme is used on the smallest deadline packets to choose which packet to transmit.

According to one or more aspects and embodiments of the invention, the deadline may be adjusted by each component a packet passes through. For example, the component may decrement the deadline of the packet. For another example, the component may increment the deadline of the packet.

According to one or more aspects and embodiments of the invention, deadlines may be set on a per packet basis. Arbitration may be determined based on the presence of the deadline or the absence of the deadline. According to one or more aspects and embodiments of the invention, the deadline may be set to a value that represents infinity. For example, the deadline may be set to a reserved word for infinity. Arbitration may be determined based on deadline being infinity. For example, arbitration may resolve in favor of packets that have a deadline that is not infinity. According to one or more aspects and embodiments of the invention, the deadline may be set to a value that will not be adjusted and will always lose arbitration to a packet with a deadline not set to the value.

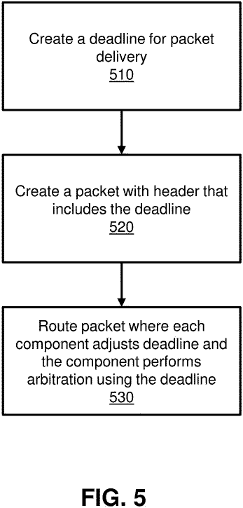

Referring now to FIG. 5, shown is a process of using deadline based arbitration within a NoC in accordance with the various aspects and embodiments of the invention. At step 510, a deadline is created for packet delivery. According to one or more aspects and embodiments of the invention, step 510 may be the same or similar to step 410. At step 520, a packet is created with a header that includes the deadline. According to one or more aspects and embodiments of the invention, step 520 may be the same or similar to step 420. At step 530, the packet is routed within the NoC where each component adjusts deadline and the component performs arbitration using the deadline. According to one or more aspects and embodiments of the invention, step 530 may be the same or similar to step 430.

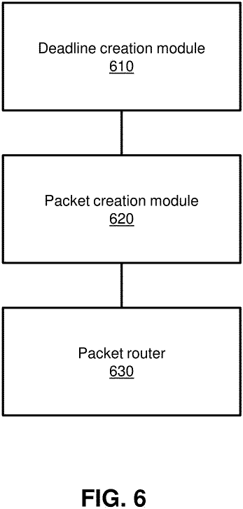

Referring now to FIG. 6, shown is an apparatus for using deadline based arbitration within a NoC in accordance with the various aspects and embodiments of the invention. Deadline creation module 610 creates a deadline. According to one or more aspects and embodiments of the invention, deadline creation module 610 may perform the same or similar function to step 410. According to one or more aspects and embodiments of the invention, deadline creation module 610 may perform the same or similar function to step 510. Packet creation module 620 creates a packet with the deadline. As discussed herein, the deadline value is added to the packet. According to one or more aspects and embodiments of the invention, packet creation module 620 may perform the same or similar function to step 420. According to one or more aspects and embodiments of the invention, packet creation module 620 may perform the same or similar function to step 520. Packet router 630 routes the packet. According to one or more aspects and embodiments of the invention, packet router 630 performs the same or similar function to step 430. According to one or more aspects and embodiments of the invention, packet router 630 performs the same or similar function to step 530.

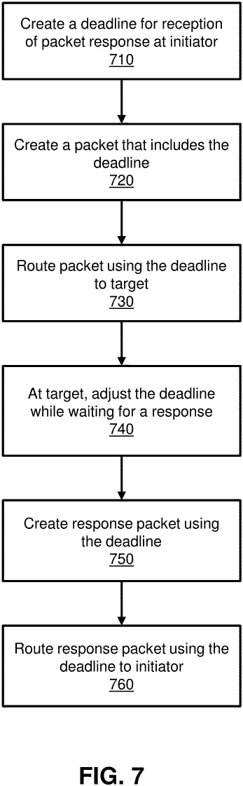

Referring now to FIG. 7, shown is a process of using deadline based arbitration in a request and response cycle in accordance with the various aspects and embodiments of the invention. At step 710, a deadline is created for reception of packet response at an initiator. According to one or more aspects and embodiments of the invention, the deadline may be for a sequence of packets. For example, the deadline may include the time for three request and response cycles to complete. According to one or more aspects and embodiments of the invention, step 710 may be the same or similar to step 410. According to one or more aspects and embodiments of the invention, step 710 calculates the deadline that includes the time for a response. According to one or more aspects and embodiments of the invention, step 710 may be the same or similar to step 510 and includes calculating the deadline that includes the time for a response.

At step 720, a packet is created that includes a deadline. According to one or more aspects and embodiments of the invention, step 720 may be the same or similar to step 420. According to one or more aspects and embodiments of the invention, step 720 may be the same or similar to step 520.

At step 730, the packet is routed within the NoC, using the deadline, to a target. According to one or more aspects and embodiments of the invention, step 730 may be the same or similar to step 430. According to one or more aspects and embodiments of the invention, step 730 may be the same or similar to step 530.

At step 740, at the target, the deadline is adjusted while waiting on a response. For example, the deadline may be decremented while waiting on the response. For another example, when the initiator is a central processing unit (CPU) and the target is an analog to digital converter (ADC), then the packet may include the command for the ADC to perform an analog to digital conversion. While the ADC is performing the conversion, the deadline is decremented to account for the time taken for the conversion to be performed. According to one or more aspects and embodiments of the invention, the deadline may be stored in a context table. The deadline in the context table may be adjusted while waiting on a response.

At step 750, a response packet is created using the deadline. To continue the ADC example, the response packet is created to include the ADC conversion value and the deadline. According to one or more aspects and embodiments of the invention, the deadline may be retrieved from a context table.

At step 760, the response packet is routed to the initiator using the deadline for the response or the original deadline adjusted for the time needed to travel to the target. According to one or more aspects and embodiments of the invention, step 760 is the same or similar to step 730 except step 760 routes from the target to the initiator.

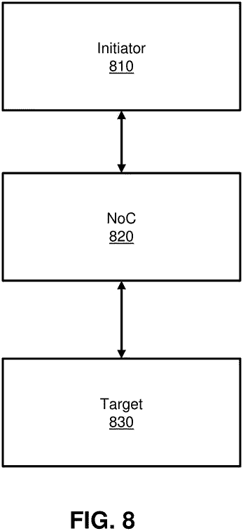

Referring now to FIG. 8, shown is a system that uses deadline based arbitration in a request and response cycle in accordance with the various aspects and embodiments of the invention. Initiator 810 generates a packet with a deadline or a deadline is added to the packet. According to one or more aspects and embodiments of the invention, initiator 810 may perform the same or similar function to step 710 and/or step 720. NoC 820 routes the packet to target 830. According to one or more aspects and embodiments of the invention, NoC 820 may perform the same or similar function to step 730. Target 830 adjusts the deadline while generating or waiting on a response. According to one or more aspects and embodiments of the invention, target 830 may perform the same or similar function to step 740. Target 830 creates a response packet, wherein the response packet includes the deadline. According to one or more aspects and embodiments of the invention, target 830 may perform the same or similar to step 750. NoC 820 routes the response packet using the deadline to the initiator 810. According to one or more aspects and embodiments of the invention, NoC 820 may perform the same or similar to step 760.

According to one or more aspects and embodiments of the invention, in a request and response sequence, the packets in one direction may require corresponding packets in another direction, which can create a fixed packet sequence. A request packet may be followed by a corresponding response packet which creates a request to response packet sequence. A sequence may include multiple requests and/or responses.

According to one or more aspects and embodiments of the invention, the initial value of the deadline encodes the expected maximum time for a sequence of packets to finish from initial request to final received response. According to one or more aspects and embodiments of the invention, arbiters and other NoC components adjust the deadline value. For example, decrement the deadline value.

According to one or more aspects and embodiments of the invention, when a packet P[i] reaches a target D[i], which is an intermediate step in a sequence of packets (P[0], P[1], ... P[i],...P[n]), then the target decrements the deadline by the time elapsed between the arrival of the incoming packet P[i] and the departure of the following packet P[i+1] in the sequence, and uses this value as the new initial value for the deadline in that packet P[i+1].

According to one or more aspects and embodiments of the invention, if a request packet P0 is sent by a network interface unit NIU0 connected to an initiator I0, to a Network Interface Unit NIU1 connected to a target T0; and the protocol expects a response packet P1 in return, sent back by NIU1 to NIU0, then NIU0 will compute a deadline value that represents the maximum time allowed for the sequence of packets (P0, P1). When P0 reaches NIU1, NIU1 records the value of the deadline for the incoming packet P0, then measures the time taken by the target T0 to respond and NIU1 to create the response packet P1. The response packet P1 deadline value is computed as the incoming deadline value of P0, minus the time elapsed for target T0 to respond and NIU1 to create the response packet P1. Then packet P1 is sent back to NIU0.

According to one or more aspects and embodiments of the invention, NIU0 may also use the deadline value of P1 at arrival, to perform further regulation activities, such as changing the way new deadline values for subsequent request packets based on the average value of the deadline of previous response packets.

According to one or more aspects and embodiments of the invention, at request packet creation a deadline is calculated and set in the header of the packet. As the request packet flows through the NoC, at each stop for arbitration, the deadline is decremented for a value depending on the time the packet is waiting. In an arbiter with the NoC, a packet with the smallest deadline of all the packets waiting for selection is chosen and the chosen packet is transmitted. After packet arrives at target, the deadline is stored in a context table. While waiting for response to arrive, the deadline values in the context table is decremented. When the corresponding response arrives then the deadline value is fetched of response packet from context table. As the response packet flows through the NoC, at each stop for arbitration, the deadline is decremented for a value depending on the time the packet is waiting. In an arbiter with the NoC, a packet with the smallest deadline of all the packets waiting for selection is chosen and the chosen packet is transmitted.

According to one or more aspects and embodiments of the invention, in a request and response cycle, the header may be given a response deadline that will be used for the response.

According to one or more aspects and embodiments of the invention, the deadline mechanism can be extended beyond the request and response to any sequence where packets are created. For example, a fixed sequence of creating packets. For another example, the deadline of future packets is adjusted based in the deadline of the packet as the packet arrives at a destination. This adjustment can be carried to future deadline creation in order to optimization of the NoC

According to one or more aspects and embodiments of the invention, the deadline can be combined with priority. Packet’s headers can have a priority field, indicating how urgent the packet is. Then, instead of decrementing by a fixed amount the deadline values of waiting packet, the higher priority packets may be decremented by a higher value. In other words, higher priority packets age faster. A potential benefit is to allow a packet to cross the NoC faster.

According to one or more aspects and embodiments of the invention, deadline values of incoming packets represent the difference between the maximum time the initiator has given the packets to arrive at the target, and the time they have spent inside the network. This difference can be used to control regulation mechanisms such as credits exchanged between target and initiator. When a packet arrives with time left beyond the initial time budget, subsequent packets from the same initiator can be given less credits by a target, since the assumption can be made that this initiator is getting the expected service level. Alternatively, when a packet arrives with little time left compared to the initial budget, subsequent packets from the same initiator can be given more credits by a target, since the assumption can be made that this initiator is getting below the expected service level.

According to one or more aspects and embodiments of the invention, statistics counters can be implemented that capture information about the value of the received packet’s deadlines. The user can monitor these counters to implement additional regulation. Any metric may be measured. For example, minimum, average, maximum values of the remaining deadline (e.g., slack) of incoming packets, histograms, etc.

According to one or more aspects and embodiments of the invention, the deadline based arbitration may also provide a way to observe overall system behavior even when the deadline field would not be used as a way to improve arbitration. Measuring transport latency accurately requires tracking tables at each ingress point and measuring outbound and return latency of packets is not possible without additional logic. These tracking tables can be large. The deadline field provides a way to observe the travel time of any individual packet and collect statistics based on initiator, target, address, or other properties.

According to one or more aspects and embodiments of the invention, the deadline arbitration scheme is useful in the field of large servers, artificial intelligence computations, and deep network accelerators. The deadline arbitration scheme works well for mesh NoC topologies, which are common in these applications. Mesh topologies expose deep cascades of switches, and deadline-based arbitration is giving better results for deep cascades of switches (e.g., arbiters).

According to one or more aspects and embodiments of the invention, an arbitrator can include a queue of packets contending for the output and the arbitrator can inspect the deadline field of each header to determine which packet to let progress to the output port. For example, the smallest deadline could be allowed to progress.

According to one or more aspects and embodiments of the invention, packets that do not have a timeframe to be “delivered in” may have the deadline header field set to a value to indicate the deadline is not to be used in arbitration.

According to one or more aspects and embodiments of the invention, any system for tracking time can be used.

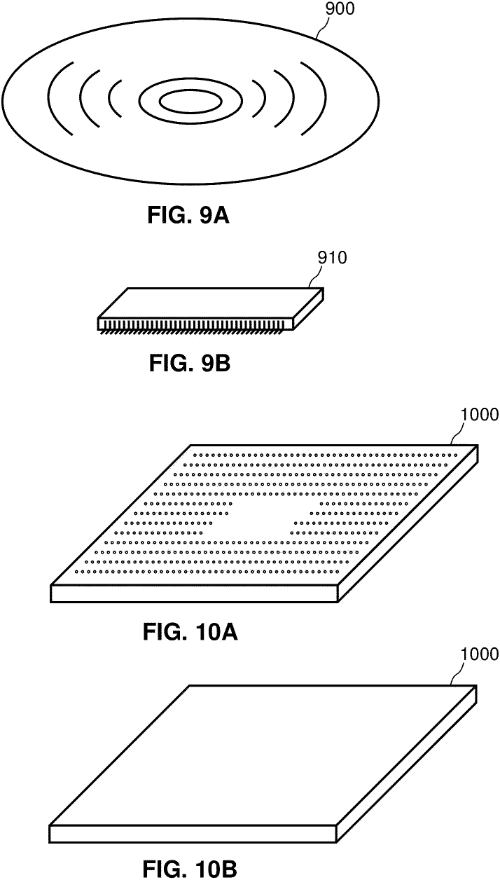

Referring now to FIG. 9A, shown is a non-transitory computer readable rotating disk medium 900 that stores computer code that, if executed by a computer processor, would cause the computer processor to perform methods or partial method steps described herein.

Referring now to FIG. 9B, shown is a non-transitory computer readable random access memory (RAM) chip medium 910 that stores computer code that, if executed by a computer processor, would cause the computer processor to perform methods or partial method steps described herein.

Referring now to FIG. 10A, shown is the bottom (solder ball) side of a packaged system-on-chip (SoC) 1000, which includes multiple computer processor cores having a component and at least one NoC in accordance with some embodiments of the invention and that, by executing computer code, perform methods or partial method steps described herein.

Referring now to FIG. 10B, shown is the top side of the SoC 1000, which is an example of the one or more non-transitory computer readable media arranged to store instructions for methods described herein. Whatever machine, which holds non-transitory computer readable media including any of the necessary code, may implement an example or an aspect of the invention. Some examples may be implemented as: physical devices such as semiconductor chips; hardware description language representations of the logical or functional behavior of such devices; and one or more non-transitory computer readable media arranged to store such hardware description language representations. Descriptions herein reciting principles, aspects, and embodiments encompass both structural and functional equivalents thereof. Elements described herein as coupled have an effectual relationship realizable by a direct connection or indirectly with one or more other intervening elements.

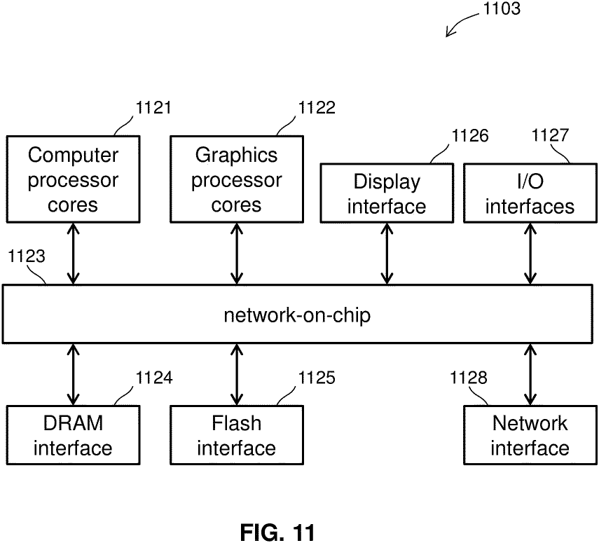

Referring now to FIG. 11, a block diagram of the cores within the system-on-chip (SoC)1103 is shown. The system 1103 includes a multi-core computer processor (CPU) 1121 and a multi-core graphics accelerator processor (GPU) 1122. The CPU 1121 and GPU 1122 are connected through a NoC 1123 to a DRAM interface unit 1124 and a Flash RAM interface unit 1125. A display interface unit 1126 is connected to controls a display, enabling the system 1103 to output MPEG video and JPEG still image message content as well as other files. An I/O interface unit 1127 provides for speaker and microphone access for the human-machine interface of a device controlled by SoC 1103. A network interface unit 1128 provides access for the system 1103 to communicate with remote locations (such as servers) over the internet or a wireless network or a local area network.

Certain methods according to the various aspects of the invention may be performed by instructions that are stored upon a non-transitory computer readable medium. The non-transitory computer readable medium stores code including instructions that, if executed by one or more processors, would cause a system or computer to perform steps of the method described herein. The non-transitory computer readable medium includes: a rotating magnetic disk, a rotating optical disk, a flash random access memory (RAM) chip, and other mechanically moving or solid-state storage media. Any type of computer-readable medium is appropriate for storing code having instructions according to various examples and aspects of the invention.

Certain examples have been described herein and it will be noted that different combinations of different components from different examples may be possible. Salient features are presented to better explain examples; however, it is clear that certain features may be added, modified, and/or omitted without modifying the functional aspects of these examples as described.

Practitioners skilled in the art will recognize many modifications and variations. The modifications and variations include any relevant combination of the disclosed features. Descriptions herein reciting principles, aspects, and embodiments encompass both structural and functional equivalents thereof. Elements described herein as “coupled” or “communicatively coupled” have an effectual relationship realizable by a direct connection or indirect connection, which uses one or more other intervening elements. Embodiments described herein as “communicating” or “in communication with” another device, module, or elements include any form of communication or link and include an effectual relationship. For example, a communication link may be established using a wired connection, wireless protocols, near-filed protocols, or RFID.

Certain methods according to the various aspects of the invention may be performed by instructions that are stored upon a non-transitory computer readable medium. The non-transitory computer readable medium stores code including instructions that, if executed by one or more processors, would cause a system or computer to perform steps of the method described herein. The non-transitory computer readable medium includes: a rotating magnetic disk, a rotating optical disk, a flash random access memory (RAM) chip, and other mechanically moving or solid-state storage media. Any type of computer-readable medium is appropriate for storing code having instructions according to various examples and aspects of the invention.

Certain examples have been described herein and it will be noted that different combinations of different components from different examples may be possible. Salient features are presented to better explain examples; however, it is clear that certain features may be added, modified, and/or omitted without modifying the functional aspects of these examples as described.

To the extent that the terms “including”, “includes”, “having”, “has”, “with”, or variants thereof are used in either the detailed description and the claims, such terms are intended to be inclusive in a similar manner to the term “comprising.”

The scope of the invention, therefore, is not intended to be limited to the exemplary embodiments and aspects that are shown and described herein. Rather, the scope and spirit of the invention is embodied by the appended claims.

What is claimed is:

1. A method of deadline arbitration in a network-on-chip (NoC) in communication with an initiator and a target:
creating, using a deadline creation module, a deadline for packet delivery;
generating, at a packet creating module, a packet that includes the deadline; and
selecting the packet, with a packet routing module, to route within the NoC using at least the deadline for arbitration between the packet and other packets being routed by the NoC.

2. The method of claim 1, wherein the deadline is stored within the packet header.

3. The method of claim 1, wherein routing the packet includes adjusting the deadline when waiting on arbitration.

4. The method of claim 1 further comprising adjusting the deadline by subtracting from the deadline arbitration time, wherein arbitration is determined by selecting from one or more packets with a smallest deadline.

5. The method of claim 1, wherein routing the packet includes selecting the packet with the deadline closest to a target deadline value when arbitrating.

6. The method of claim 1, wherein the packet includes a priority and routing the packet includes using the deadline and the priority.

7. The method of claim 6, wherein routing packet includes adjusting deadline by an amount based on the priority when waiting on arbitration.

8. The method of claim 1, wherein the deadline is set to a reserved value and arbitration is lost to one or more packets that have the respective deadlines set to a value other than the reserved value.

9. The method of claim 1, wherein a respective deadline of future packets is adjusted based in the deadline of the packet when the packet arrives at a destination for optimization of the NoC.

10. The method of claim 1, further comprising:
adjusting deadline at target while waiting on a response after the packet has arrived at a destination;
creating a response that includes the deadline at the target; and
routing the response to the initiator using the deadline.

11. A system comprising:
a processor; and
memory, wherein the memory stores code that is executed by the processor to cause the system to:
create a deadline for packet delivery;
modifying a packet from an initiator to include the deadline; and
route the packet within a network-on-chip (NoC) using at least the deadline and the packet’s address.

12. The system of claim 11, wherein the deadline is stored within the packet header.

13. The system of claim 11, wherein routing the packet includes adjusting deadline when waiting on arbitration.

14. The system of claim 13, wherein adjusting deadline includes subtracting from the deadline and arbitration is determined by selecting from one or more packets with the smallest deadline.

15. The system of claim 11, wherein routing the packet includes selecting the packet with the deadline closest to a target value when arbitrating.

16. The system of claim 11, wherein the packet includes a priority and routing the packet includes using at least the deadline and at least the priority.

17. The system of claim 16, wherein routing packet includes adjusting deadline by an amount proportional to the priority when waiting on arbitration.

18. The system of claim 11, wherein the deadline is set to a reserved value and arbitration is lost to one or more packets that have the respective deadlines set to a value other than the reserved value.

19. The system of claim 11, wherein a respective deadline of future packets is adjusted based in the deadline of the packet when the packet arrives at a destination.

20. The system of claim 11, wherein the system is further caused to:
adjust deadline at target while waiting on a response after the packet has arrived at a destination;
create a response that includes the deadline at the target; and
route the response to the initiator using the deadline.
